(19) United States
(12) Patent Application Publication
(10) Pub. No.: US 2020/0046062 A1
(43) Pub. Date: Feb. 13, 2020

(54) ARTICLES OF FOOTWEAR

(71) Applicant: C & J CLARK INTERNATIONAL LIMITED, Somerset (GB)

(72) Inventors: Antony PERILLO, Somerset (GB); Marijke BRUGGINK, Somerset (GB); Graham FOOTE, Somerset (GB); Ben QUARTLY, Somerset (GB); Paul REES, Somerset (GB); Alex MURRAY, Somerset (GB); Mark DAVENPORT, Somerset (GB); Ross AUTHERS, Somerset (GB)

(21) Appl. No.: 16/343,079

(22) PCT Filed: Oct. 20, 2017
(86) PCT No.: PCT/EP2017/076862

§ 371 Date: Apr. 18, 2019

(30) Foreign Application Priority Data
Oct. 20, 2016 (GB) 1617777.6
Jun. 13, 2017 (GB) 1709384.0

(51) Int. Cl. A43B 3/12; B29D 35/12; B29C 64/118; A43B 23/02

(52) U.S. Cl. CPC A43B 3/122; B29D 35/126; B33Y 10/00; A43B 23/0235; B29C 64/118

(57) ABSTRACT

A component for an article of footwear and methods for manufacture thereof are disclosed. The component comprises a first portion of base material of and a second portion of added material. The second portion is bonded to the base material of the first portion by a process of adding material on the base material and the added material forms at least one fastening member for fastening the component to another component of the article of footwear.

This disclosure relates to articles of footwear, components and assembly of articles of footwear, and manufacture of components for articles of footwear.

An article of footwear can comprise e.g. a shoe, sandal, boot or the like or a component of a footwear. Typical components of footwear comprise an upper and a sole. Various components can also be manufactured that form only a part of an upper or a part of a sole. Upper and sole components and/or parts thereof can be attached together during manufacture. An upper can be made from various materials, for example leather, different fabrics and textiles and/or synthetic materials. A sole is typically made from hardwearing materials, e.g. rubber or hardwearing synthetic materials. A sole may also contain other types of materials, for example leather, fabric or softer synthetic materials. Components for footwear can comprise layers of different materials.

The assembly and attachment of various components together can be based on various techniques, such as stitching, gluing, nailing and merging the materials under heat and/or pressure and so on. This can be labour intensive, costly and time consuming. Also, it might be desirable to be able to flexibly produce footwear based on components thereof as close to the point of sale as possible. Flexible assembly and disassembly might also be desired.

Producing required components for each line, style and variant of footwear may also require specific moulds and other specialised tooling. As a consequence, the making of footwear can be costly and time consuming, and thus not economically viable for all product lines. Production of large volumes of footwear of a model/style in various sizes and variants that do not sell well can result in considerable wastage of resources.

Customization based on information of the actual customer buying the footwear might also be desired.

The embodiments aim to address one or more of issues in relation to articles of footwear.

According to an aspect there is provided a component for an article of footwear, the component comprising a first portion of base material and a second portion of added material, wherein the second portion is bonded to the base material of the first portion by a process of adding material on the base material and the added material forms at least one fastening member for fastening the component to another component of the article of footwear.

According to another aspect there is provided a method of manufacturing a component for an article of footwear, the method comprising adding material on a first portion of the component to form a second portion of the component such that the second portion provides a fastening member for fastening the component to another component of the article of footwear, the adding comprising bonding the moulded material of the second portion with the material of the first portion.

According to more specific aspects at least one fastening member is configured to engage with a co-operating fastening member provided at the other component. At least one fastening member may be arranged for fastening an upper to a sole. A first part of an upper and at least one fastening member may be arranged for fastening the first part of the upper to a second part of the upper. At least a part of a sole and at least one fastening member may be arranged for fastening the at least one part of the sole to an upper and/or to a second part of the sole.

The added material may be applied on adjoining surfaces of the first portion and the other component so that a fixed joint is provided by the added material between the component and the other component.

At least one fastening member may comprise at least one barbed element or clasp element for locking to the other component. At least one fastening member comprises a grid structure or at least one aperture for locking to the other component. At least one fastening member may comprise at least one opening for receiving a holding member. At least one fastening member may comprise at least one tongue like element extending from the first portion for fastening to the other component.

The at least one fastening member may be 3D printed and/or moulded. Material that settle without use of curing agent may be used. The second portion may be 3D printed or moulded on the first portion such that the 3D printed or moulded material forms a rim extending substantially around the entire outer edge of the first portion. The 3D printed or moulded material may alternatively cover only a part of the outer edge of the first portion.

A component for an article of footwear according to any preceding claim, wherein the added material comprises elastic material. The added material may comprises at least one of thermoplastic polyurethane, thermoplastic elastomer, thermosetting polymer and two-part thermosetting polymer. The first portion may comprise at least one of leather, synthetic leather, fabric, felt, rubber, plastic, and foam material.

An article of footwear comprising a component as described herein may also be provided wherein co-operating fastening members are arranged for locking components to each other.

Various exemplifying embodiments of the invention are described below with reference to the attached drawings. Steps and elements explained herein may be reordered, omitted, and combined to form different embodiments and any step indicated as performed may be caused to be performed in another order. In the drawings:

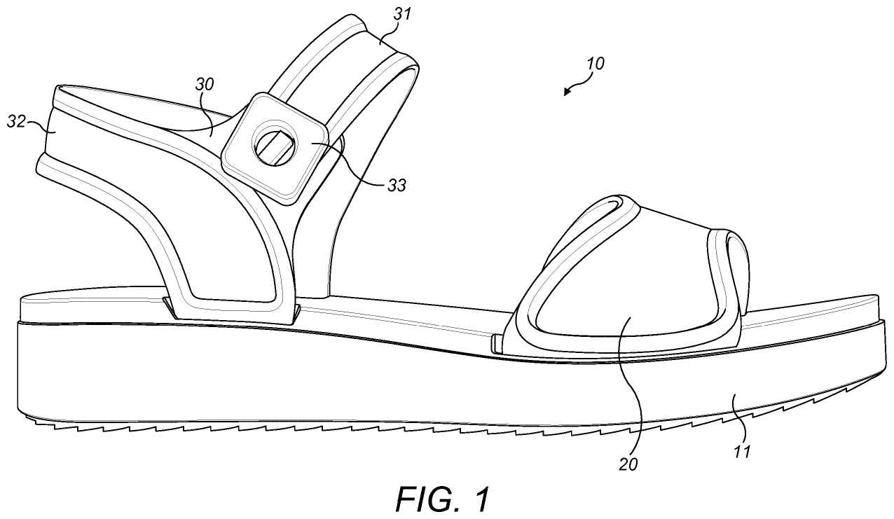

FIG. 1 is a side view of an example of footwear;

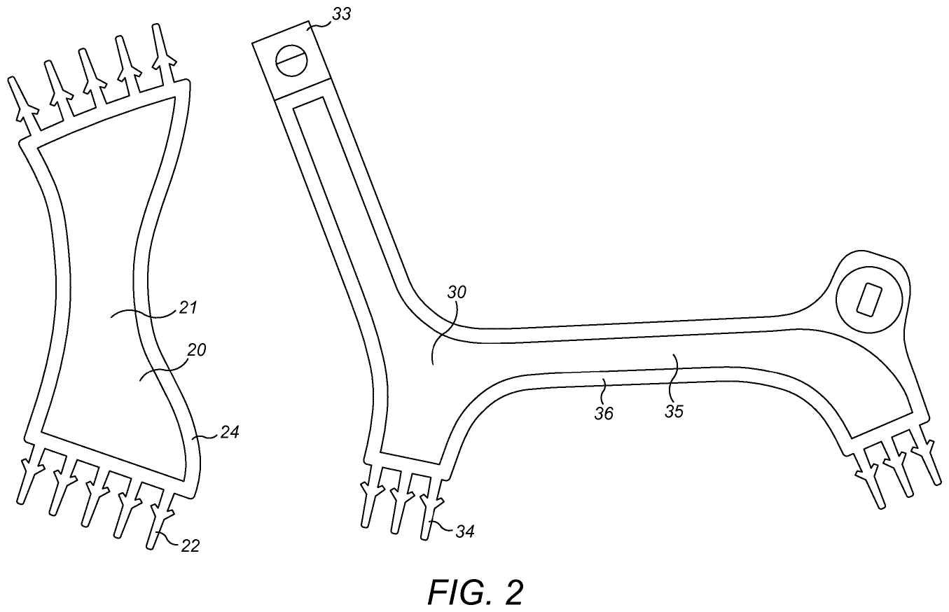

FIG. 2 shows upper components for the footwear of FIG. 1;

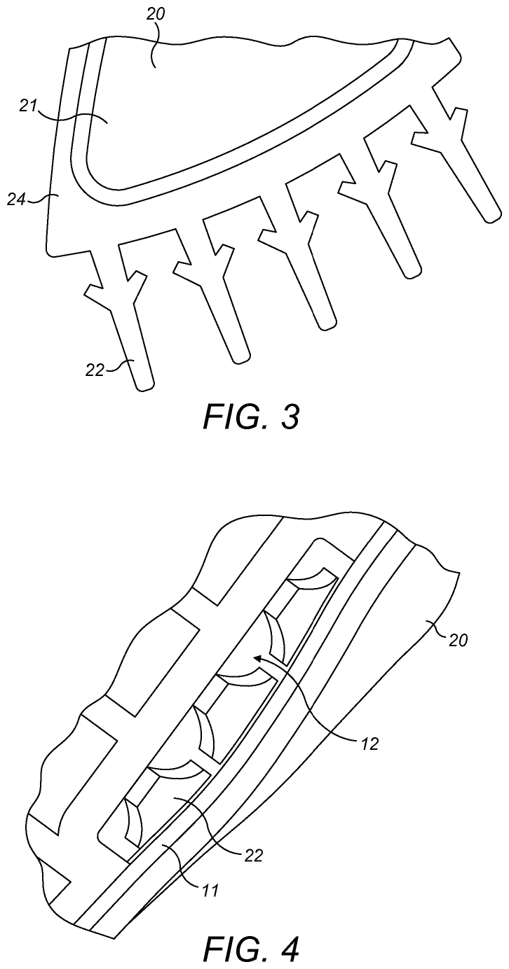

FIG. 3 shows a view of a detail of the upper component of FIG. 2;

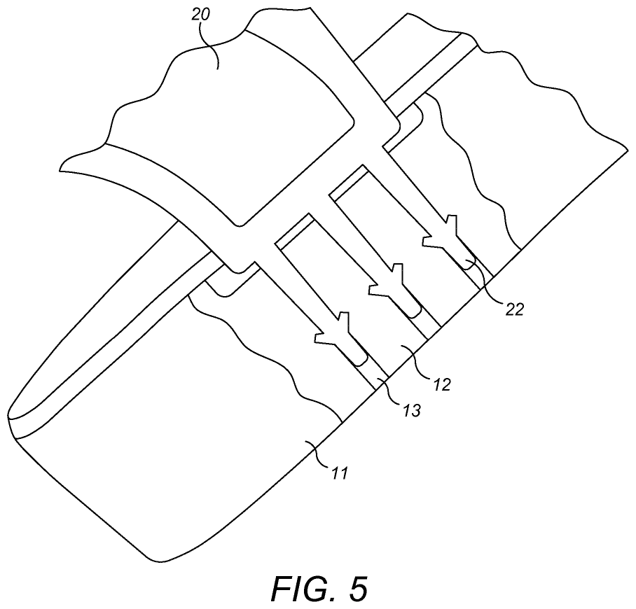

FIGS. 4 and 5 show an example of attaching sole and upper components to form a footwear assembly according to an embodiment;

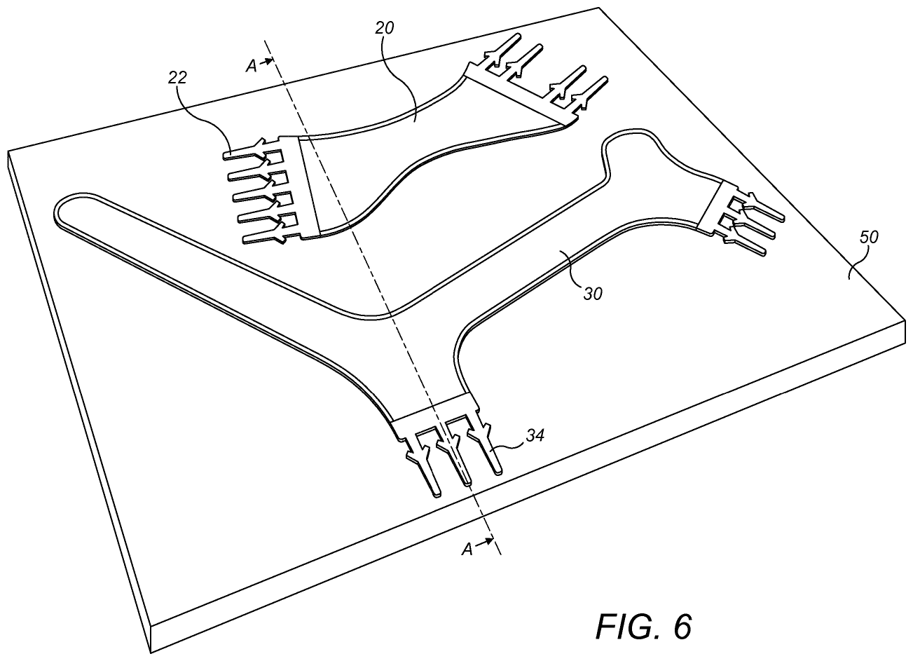

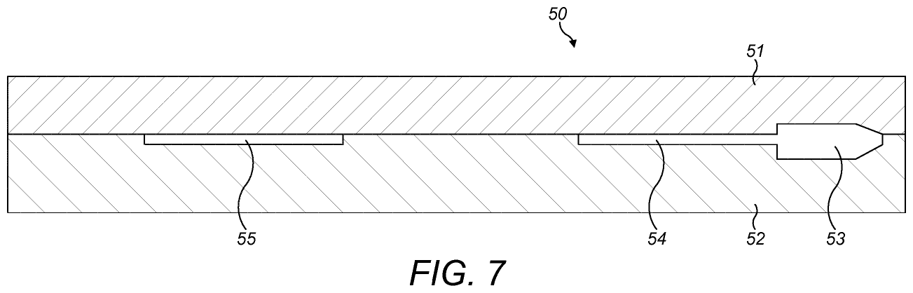

FIGS. 6 and 7 show an example of a mould;

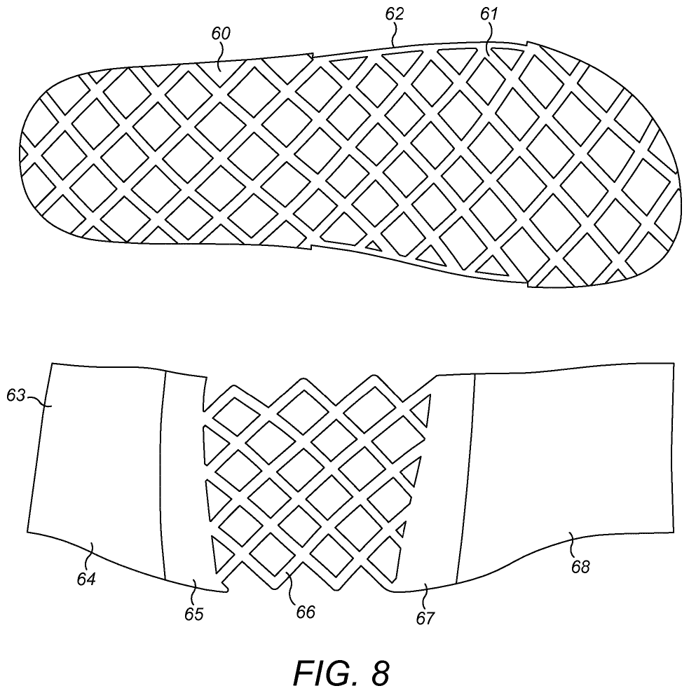

FIGS. 8, 9, 10 and 11 show further examples for securing an upper to a sole;

FIG. 12 is a cross sectional view of an exemplifying component;

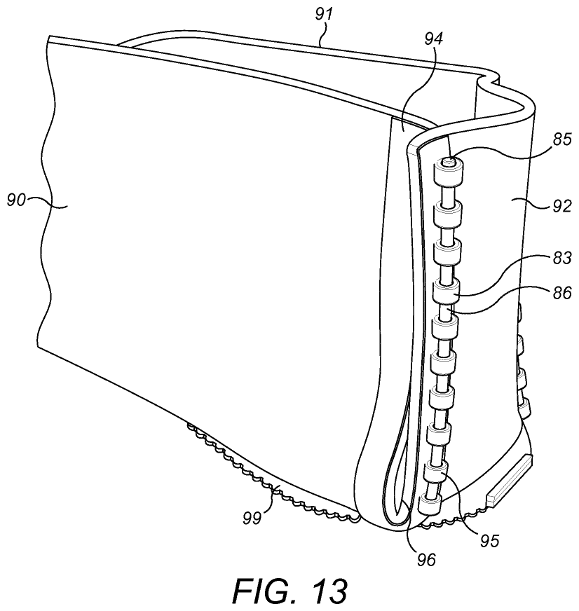

FIGS. 13 to 16 show further examples of attaching components of footwear together;

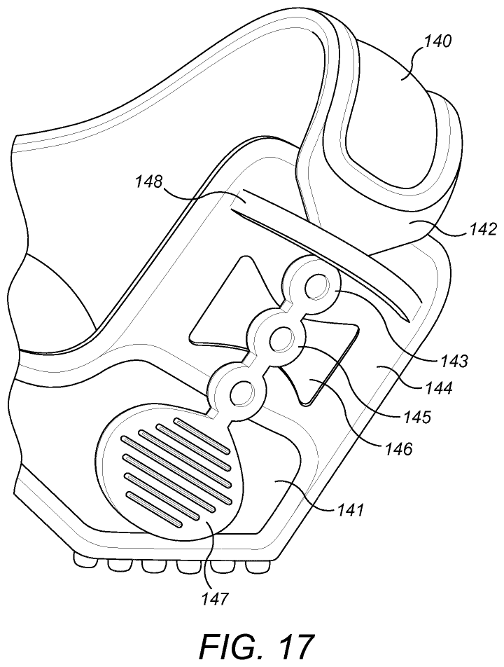

FIGS. 17 to 20 show further examples;

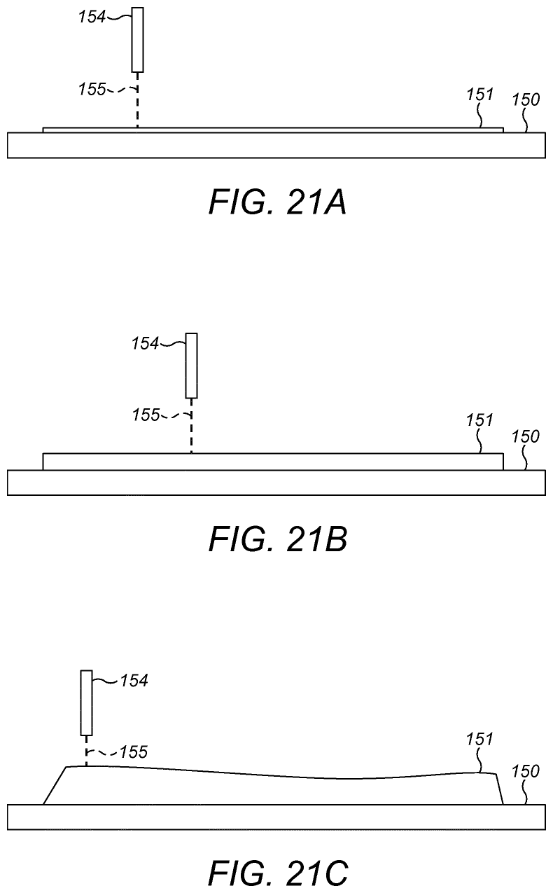

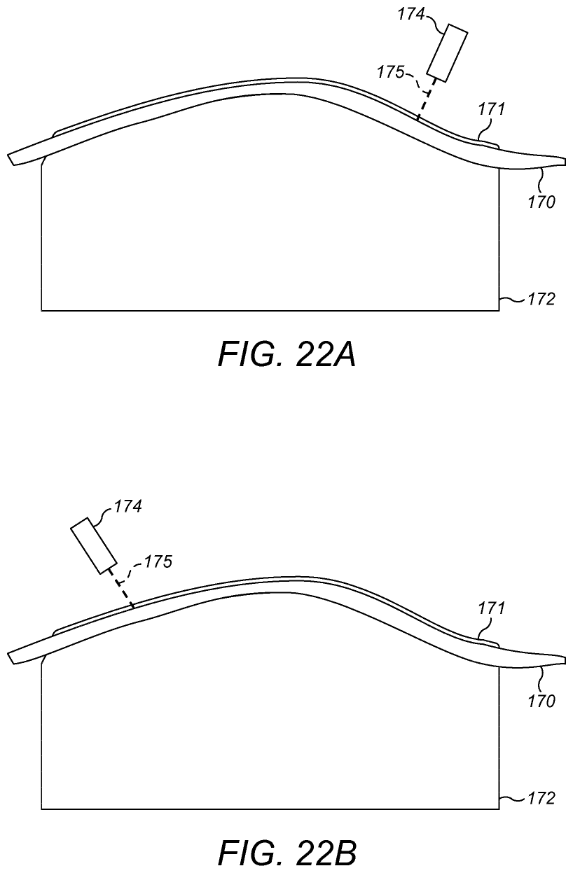

FIGS. 21A, 21B, 21C, 22A and 22B shoes examples related to 3D printing;

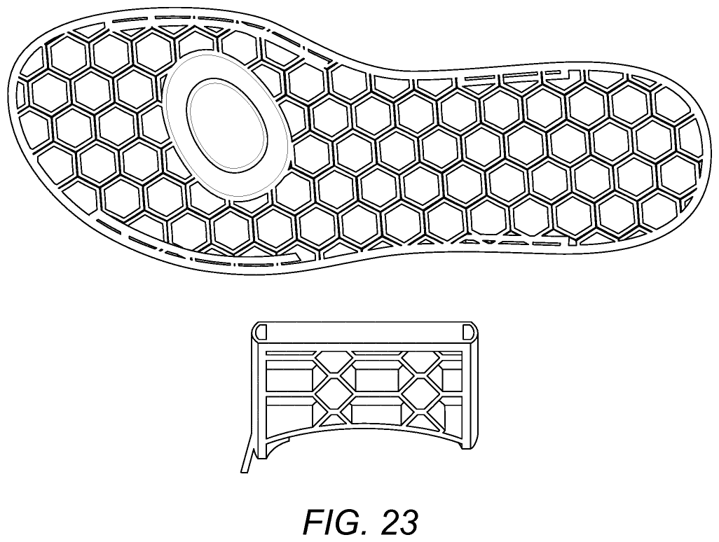

FIG. 23 is a further example of components;

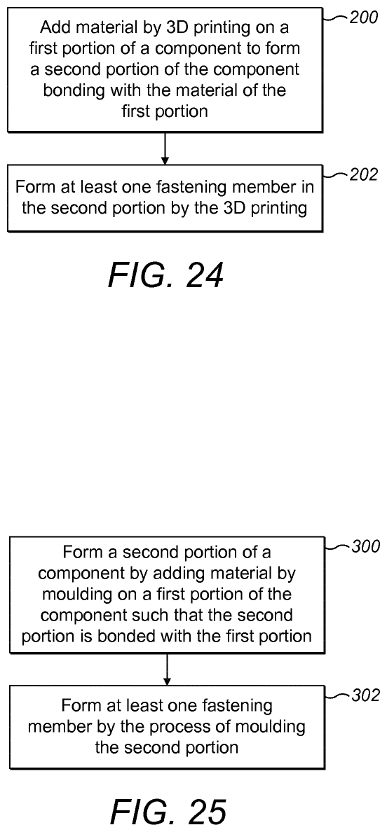

FIGS. 24, 25 and 26 are flowcharts in accordance with certain embodiments; and

FIG. 27 shows a control apparatus

In the following certain detailed examples of articles of footwear embodying the invention will be described with reference to the drawings.

FIG. 1 shows a side view of a sandal 10. Sandals are an example of footwear styles. A feature of a sandal is that the upper does not entirely enclose the foot. Instead, the upper may comprise just straps or bars of upper material to extending over the foot. A sandal may also have an orthodox upper with large cut-outs, punch holes or the like open areas leaving part(s) of the foot visible. The upper structure of the sandal of the example in FIG. 1 comprises two strap like components 20 and 30. Upper components 20 and 30 extend over a foot bed/inlaid sock provided on a sole component 11. A foot can be received within the space between the straps 31 and 20 and the sole component 11 in a known manner. Strap 20 at the front of the sandal 10 is called herein a front strap or front part of the upper. Strap 31 at the rear of the sandal is called herein a back strap of the upper. It is noted that instead of two separate straps a unitary piece or bar extending over the foot bed on the sole may also be provided. Also, more than two straps may be provided. In general, the appearance of an upper and/or sole may vary considerably from that of the examples shown herein.

FIG. 1 shows further an example of an ankle strap 32 extending rearward from the back strap 31. The ankle strap is often, but not necessarily, provided in a sandal style footwear, or other styles where the heel section is left open. One or more straps or ties extending between the upper straps 20 and 30 are also possible. More detailed explanation of the upper components of FIG. 1 and manufacture thereof will be given below with reference to FIGS. 2-5.

The sole component 11 of the sandal 10 can be made from one or several layers of material. The sole can be produced by various techniques. A sole can comprise a plurality of components that can be joined together by various techniques.

According to an embodiment a component for an article of footwear comprises a first portion and a therein integrated second portion. The first portion may provide a main part of appearance of a conventional component of footwear. The second portion is arranged for fastening the component to another component of the article of footwear, and/or for providing reinforcement or stiffening to the first portion. The second portion can provide an elastic but stiff and durable element of the component. The second portion is formed by adding material on the first portion, e.g. by 3D printing or moulding. Examples of these techniques will be explained in more detail below.

In the example of FIGS. 1-5 the component comprises an upper component 20 and/or 30. The other component where the first component is fastened to comprises a sole 11. The first portion of the upper component can comprise e.g. a piece of leather or fabric. FIG. 2 shows such leather or fabric pieces 31 and 35 of upper components 30 and 30, respectively. Other materials, components and combinations are possible, examples of which will be described later. The second portions of the upper components can comprise elastic material.

The sole component 11 can be made from one or several layers of material. The sole component can be produced by three-dimensional (3D) printing.

The second portion can be added to the first portion by 3D printing. 3D printing is an additive process where material is laid down by progressively adding material to form a product of desired shape, size and appearance. In this specification term ‘3D printing’ is used to refer to additive manufacturing processes that can be used to create physical objects from three dimensional digital data. The additive manufacturing processes can be arranged to re-form a raw material by the addition of energy and positioning in a controlled manner. The control is provided by an appropriate control unit based on the digital data. A variety of 3D printing processes are available. Also, a variety of stock materials (polymers, metals, ceramics, etc.) in differing forms (e.g. liquids, powders, granules, and filament) are available.

A possible 3D printed material for providing the herein described articles of footwear can comprise e.g. thermoplastic polyurethane, TPU, or thermoplastic elastomer, TPE. The materials can be appropriately adapted for 3D printing of the herein described components. A specific example for additive manufacturing process is fused deposition modelling (FDM). FDM uses heat to melt a thermoplastic polymer filament which is then extruded through a fine nozzle to lay a bead of material in the areas required for the form of a finished object.

The second portion of the upper components can comprise 3D printed material that has been fastened to the first portion by 3D printing process. During the printing process the 3D printed material merges and bonds with the material of the first portion thereby providing an integrated component structure. The 3D printed material printed on the first portion is further produced such that it forms at least one 3D printed fastening member for fastening the upper component to the sole component.

Elastic material can also be fastened to the first portion by an appropriate moulding process. During moulding process the moulded material merges and bonds with the material of the first portion thereby providing an integrated and strong component structure. In the example material can be moulded on the first portion such that the moulded material forms at least one fastening member for fastening the upper component to the sole component.

Moulding is a process of manufacturing where liquid or pliable raw material is shaped using a rigid frame known as a mould. A mould is typically a hollowed-out block that can be filled with a liquid or pliable material. The liquid hardens or sets inside the mould, adopting its shape. Various moulding techniques are known, non-limiting examples of these including compression moulding, extrusion moulding, injection moulding, and rotational moulding. A split mould arrangement uses two moulds, one for each half of the object. Piece-moulding uses a number of different moulds, each creating a section of a complicated object. In the current invention moulding is used to add and bond material to a part of a component for an article of footwear.

Examples of suitable materials for moulding of component parts according to the herein disclosed principles comprise thermoplastic polyurethanes, thermoplastic elastomers, thermosetting polymers and two-part thermosetting polymers. According to a specific example, a moulded component may comprise epoxy where two liquid chemicals are mixed, react and form a solid part.

In the examples of FIGS. 2-5 the fastening members comprise barbed elements 22, 34 for locking to the sole component. The shape, operational principles, features and number of the fastening members can vary from that shown.

FIGS. 4 and 5 illustrate a footwear assembly after the fastening members 22 have been inserted and locked into receiving slots between elements 12 that have been formed in the sole component 11. FIG. 4 shows an assembled footwear from below. The fastening members 22 are received in and fill the slots between the co-operating elements 12 of the sole. The fastening members of the sole and receiving slots can also have been produced by various techniques, e.g. moulding, 3D printing, cut form sheet material and so on. FIG. 5 is a part-sectioned view of the footwear of FIG. 4 from side, illustrating the slots 13 receiving the fastening members 22. Elements 12 and slots 13 thus form the cooperating fastening members of the sole.

In FIG. 2 material 24, 36 is 3D printed or moulded by adding the material onto the edge areas of the central piece 35 around the entire outer edge of the upper components. The material can be added only on one side of the material along the edge. The material can also be added to provide a trim like structure surrounding the outer edge of the central piece. This may be done to provide neater appearance, and/or for a stronger/stiffer structure, and/or more wear resistant structure.

A 3D printed or moulded rim may extend around the entire length of the component edge or only a part of the edge. Adding material on only a portion of a base material, for example on the edges thereof, may provide advantage e.g. in that a neat appearance can be provided by the selected base material (e.g. leather and/or fabric) on visible areas of a footwear whereas 3D printing or moulding can be used to produce aesthetically less important structural features such as fastening members for fastening, joining and/or clasping together different components of the footwear. This may allow for use of materials that may not require specific curing and other finishing arrangements such as use of curing agents and/or finishing equipment.

FIGS. 6 and 7 show an example of a mould 50. The mould is configured for manufacture of upper components of the style shown in FIGS. 1-5, a difference being that there is no rim extending around the edges of the base material. FIG. 6 shows a perspective view of the mould 50 when the upper part thereof is removed. FIG. 7 shows a sectioned view along line A-A of FIG. 6, with the cover part 51 being in placed on top pf the base part 52 of the mould.

During moulding process, the base material pieces 20, 30 of the upper parts are place in appropriately shaped recesses 55, 54 of the base part 52 of the mould. The top or lid part 51 of the mould is then placed on top of the base part 52. Moulding material is introduced to chambers shaped to have the external shape of the fastening members 22, 34. In FIG. 7 such a chamber is illustrated by chamber 53. Once the material has settled, the component can be removed from the mould 50.

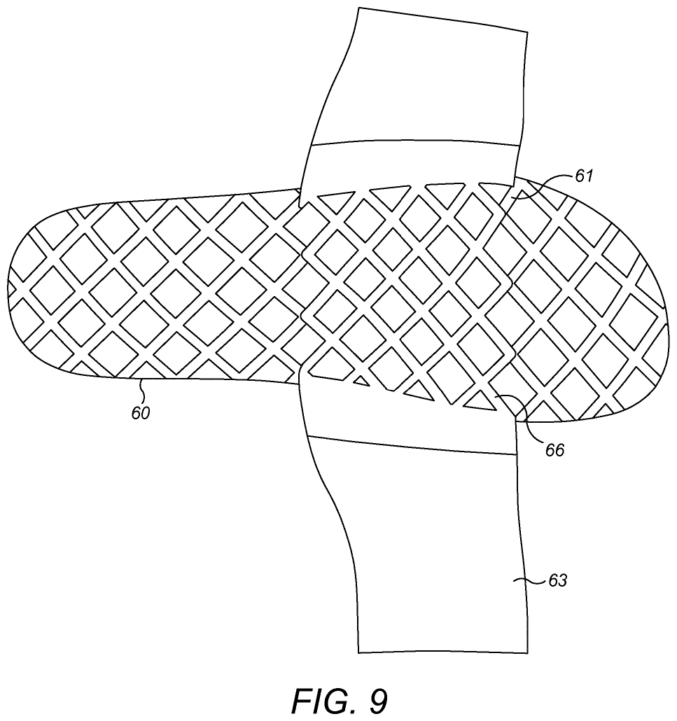

FIGS. 8 and 9 show an example where the fastening member is provided by a grid or lattice like structure 66 between sides 64, 68 of an upper component 63. The sides of the upper component can comprise e.g. leather or fabric pieces 64, 68 and therein integrated moulded portions 65, 67 providing the lattice 66 there between. Thus in the example moulded or 3D printed material is provided only on the lower edge areas of the upper component material.

The sole component 60 and detail thereof can also be made by moulding, 3D printing, cutting or so forth. Grooves 61 providing a groove pattern that matches the lattice 66 are provided on the lower surface of the sole component. A recess 62 can be arranged on both sides of the sole component for receiving the sides of the upper component 63.

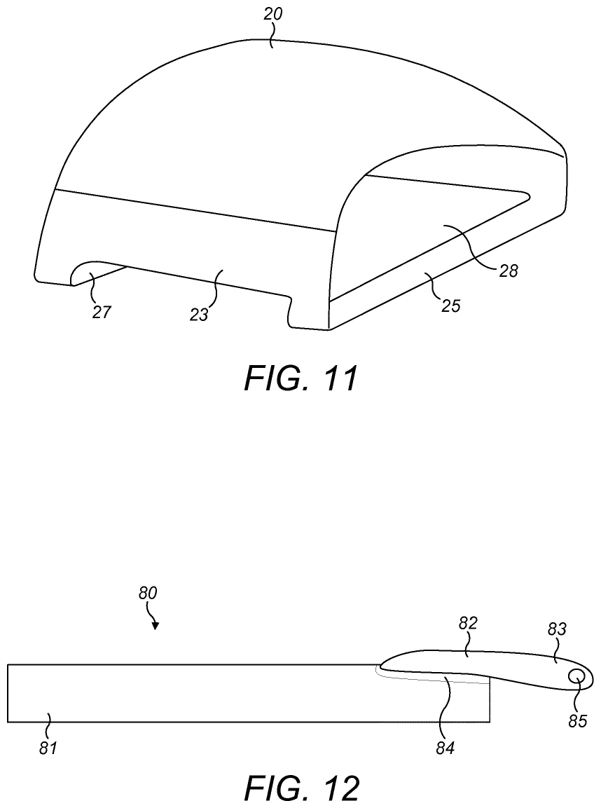

FIG. 9 illustrates the grid 66 assembled into the grooves 51 of the sole component 60, the grid providing a fastening member of the upper. The grooves 61 can be manufactured to be deeper than the thickness of the grid to protect the grid material from wear. An option is to provide a protective layer on top of the grid. For example, a bottom sole structure such as shown in FIG. 11 can be assembled on top of the grid.

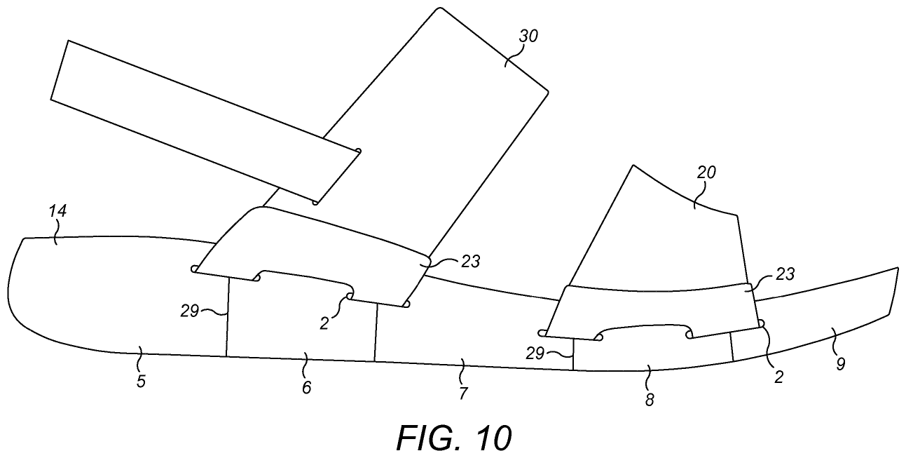

FIGS. 10 and 11 show another example wherein a looped fastening member 23 is bonded to upper pieces 20, 30 by means of moulding or 3D printing. The looped member provides an aperture, as illustrated by FIG. 11, for receiving a segment of the sole, as described below. The sole part 4 is divided into segments 5, 6, 7, 8 and 9. The division is provided by slits or gaps 29 cut or otherwise provided into the sole material such that they extend in the lower region of the sole substantially vertically and transversally from one side of the sole to the other. According to the example of FIG. 10 four gaps 29 are provided. Thus the lower part of the sole is divided into the five downwardly extending segments 5-9. Another number of divisions and segments is also possible. For example, two cuts would provide three segments. The sole structure comprises a base region at the top part thereof for holding the sole in one piece and a lower region where a plurality of segments is provided. A strap is formed in at least a part of the upper structure is arranged to form a looped connector part 23. The looped connector part 23 defines an opening 28 in the lower part of the loop such that a respective downwards protruding segment of the sole can be received and accommodated within the opening. In accordance with an aspect the opening of the looped connector member is slotted into its place. The slotting can include inserting an appropriate segment into the opening 28. At this stage the sole 14 can be flexed to open the gaps 29 to enable easy insertion of the segment into the opening of the connector part. The side edges of the opening 28 can be defined by two straps 25 forming the lower part of the looped upper. The opening 29 between the straps 25 is dimensioned and shaped to co-operate with the relevant segment so that the looped upper can be slotted in and releasably secured to the sole. To secure the looped upper to the sole at least one edge of the opening 28 can be arranged to lock with the sole when the opening of the looped member has been slotted through the slits and is located around the segment at the upper part thereof. The locking to a segment can be provided by an appropriate locking member provided in connection with the segment.

FIG. 12 is a cross-sectioned view of a component 80 comprising a first portion 81 of e.g. leather, fabric or other like material and a second portion 82 of moulded or 3D printed material. During the additive process material 82 added on the substrate material fuses with the material of the first portion 81. The region where the bonding of portions 81 and 82 together takes place is denoted by reference 84. Testing of prototypes has proved the bond to be strong enough to withstand forces footwear is expected experience in normal use. The fastening members have elastic properties and have proven appropriately flexible and stiff for the purposes of fastening footwear components to each other.

FIG. 12 also shows an example of a fastening member 83 where an opening or through hole 85 is provided by additive forming process at the end of the fastening member. During assembly the fastening member can be threaded to through a receiving opening of a counterpart component and a holding pin, flexible filament or the like can be threaded through the opening 85 to prevent the fastening member from slipping out of the receiving opening. Examples of such fastening arrangements are shown in FIGS. 13 and 14.

In FIG. 13 sides 90 and 91 of the upper component 90 are attached to a rear part 92 of the upper using a series of fastening members 83 providing through holes 85 at the ends thereof and extending through holes 95 at the rear part. A holding member such as a pin or filament 86 is threaded through the holes 85, thus preventing the fastening members 83 from slipping out of the holes 95. A strengthening piece 96 can be moulded on the rear part 92.

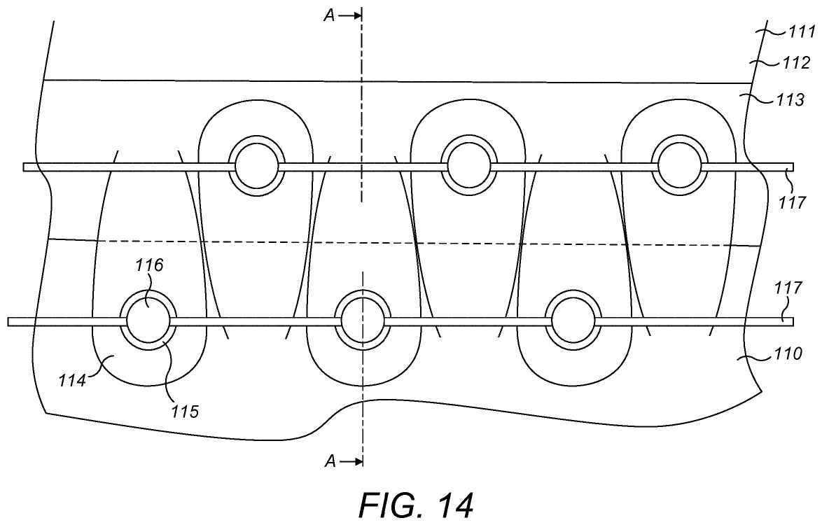

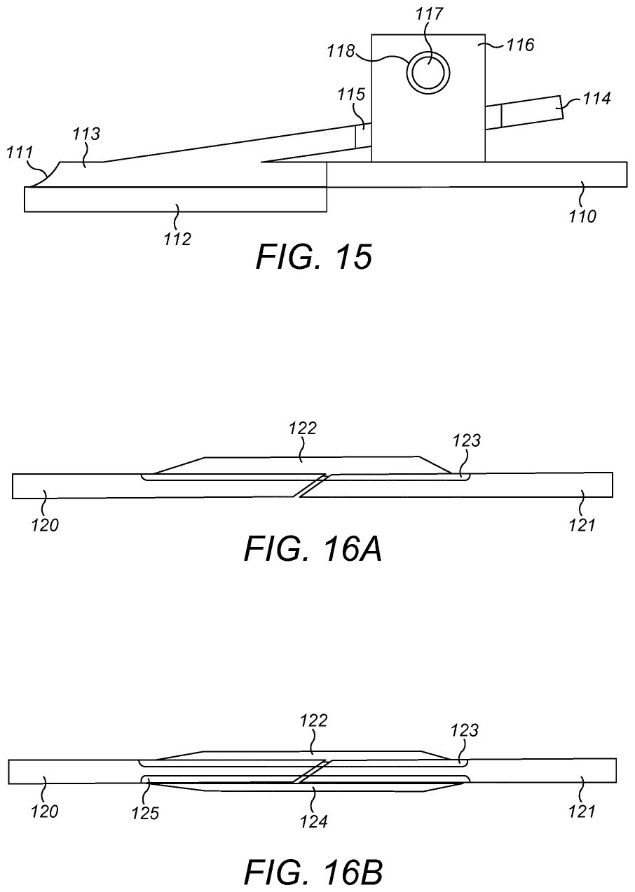

FIGS. 14 and 15 show another example of joining two components together by means of fastening members provided in one component and protruding through holes in a counterpart components. More particularly, FIG. 14 shows schematically fastening components 110 and 111 and FIG. 15 shows a cross-section along line A-A of one of the fastening members of FIG. 10. At least one of the components can be provided with moulded or 3D printed tongue or tab like fastening members 114 with an opening 115 at the outer end thereof. The counterpart component comprises a protruding element such as a stud 116 that can be pushed through the opening 115. A pin, flexible filament 117 or the like can be threaded through the openings 118 at the top of the stud to lock the tabs 114 around the studs 116.

In the example both components 110 and 111 are provided with the fastening members 114 and studs on alternate fashion. The holed tongues can interleave with each other to provide visually neat and strong fastening between the components. Other arrangements are also possible. For example, the tabs can only extend from one of the components and the studs accordingly provided only on the other component. This may be advantageous e.g. in footwear where no other moulding or 3D printing operation would be needed for the other component but e.g. simple plastic or metallic studs might be used.

FIGS. 14 and 15 also illustrate a possibility where component 111 comprises a first part 112 and a thereon moulded second part 113 whereas the second component 110 is comprised of a single piece. The second component comprising the tabs and studs of the fastening arrangement can be moulded or 3D printed in its entirety.

FIGS. 16A and 16B illustrate further examples of fastening members. In the example of FIG. 16A material 122 is moulded or 3D printed on base materials such that it extends on top of both components 120 and 121. During the process of adding the material it fuses in region 123 with the underlying substrate material provided by components 120 and 121 thereby providing a strong bond between the components.

FIG. 16B is similar but shows an example where material is 3D printed or moulded on top and bottom sides of the components 120 and 211, thus providing fastening members 122 and 124 and corresponding fused regions 123 and 125 on both sides of the joined components. The double-sided construction may allow in certain joining applications thinner layers of added material on the surfaces of the components and/or stronger joint between the components as would be the case in FIG. 16A.

FIG. 17 shows yet another example of a fastening system. In this example an adjustable arrangement is provided by a fastener for fixing two sides, or sub-components 140, 141 of an upper part together. The fastening member, 143, is moulded or 3D printed together with a rim portion 142 on the upper strap 140. The fastener comprises a tab element 147 at the free end thereof which can be used to pull the locating portion under a strap 148 and into appropriate tightness. At the desired tightness one of the holding members can be pushed into a receiving recess or slot of a counterpart locking member 146. Locking member 146 can be moulded on the surface of sub-component 141 of the upper part at the same time with edge areas 144.

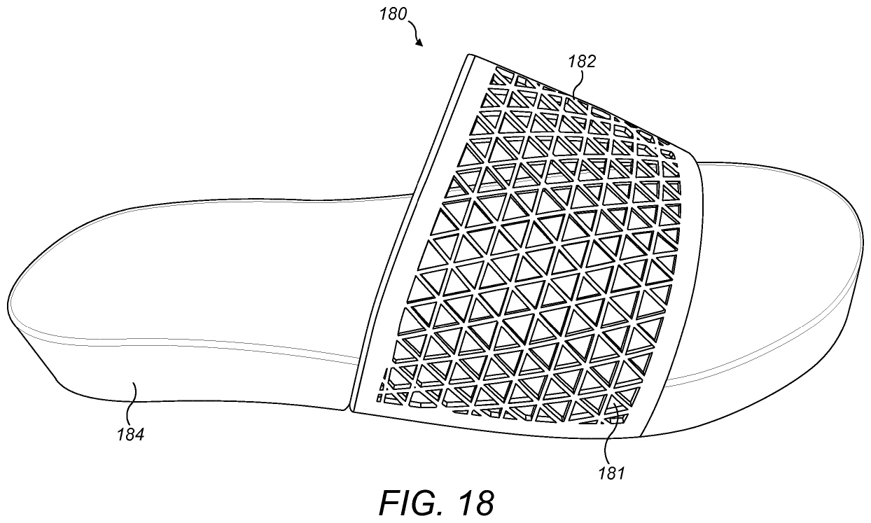

FIG. 18 is an example of an article of footwear where an upper part 180 is strengthened by moulded or 3D printed support grid structure 182 that also provides fastening members for fastening to the sole component. The grid structure is formed on material 181 such as leather of fabric which alone might not provide sufficient structural strength. The fastening members can be formed at the bottom of the grid element and be pushed to receiving openings at the sides of the sole 184. The upper component fastening members can have the shape of e.g. studs or barbed elements that can be pushed into co-operating locking recesses formed in the sole component 184.

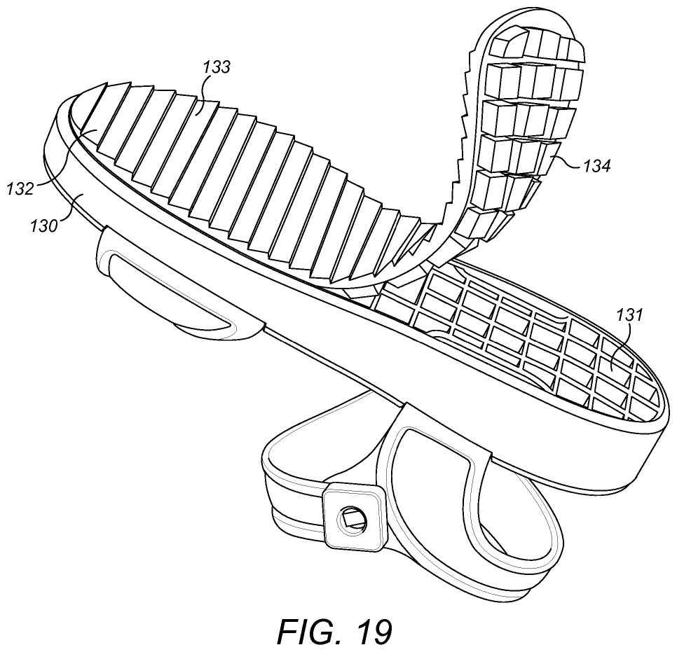

FIG. 19 shows an example of assembling two components of an article of footwear together using 3D printed or moulded fastening members. In this example the bottom side of a midsole component 130 is provided with a pattern of square like recesses 131. A bottom sole component 132 has a first portion 133 which is patterned appropriately for providing a ground contacting surface of the footwear. The other side of the bottom sole component 132 comprises protruding formations 134 that are arranged to lock into the recesses 131 of the midsole 130.

The bottom sole can be made from multiple layers e.g. such that the portion of the bottom sole providing the protruding formations 134 can be produced on a more hardwearing ground facing portion. According to an alternative the bottom sole piece comprises integrated top and bottom portions which are both formed in one material addition operation. The midsole component 130 and the recesses therein can also be 3D printed or moulded.

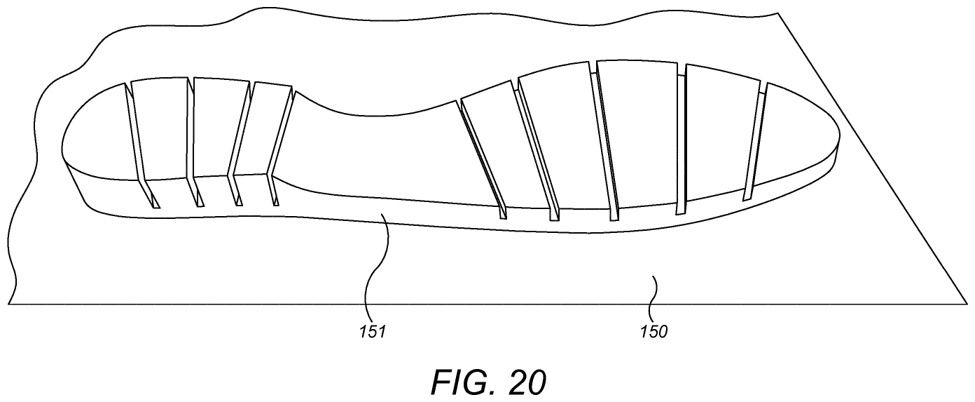

FIG. 20 shows an example of a component manufactured by means of 3D printing. More particularly, in the example a sole component 151 has been 3D printed on a piece of sheet material 150 that provides a sock, or part of a sock, or an insole, of the finished footwear. That is, the material of the sock 150 provides a substrate on which material layers forming the remainder of the sole component are added during the 3D printing process.

In accordance with a possibility one or more fastening members are produced in the sole component 151. For example, recesses or slots for receiving co-operative fastening members of the upper, or tab like elements for attachment to an upper component can be 3D printed in the sole component 151.

According to a possibility the base material on which the 3D printed material is applied to, provides at least a part of a fastening arrangement for fastening the sole component to an upper component. Appropriate fastening members can also be printed on the base material 150 for use in fixing the sole component to an upper component. The fastening members can be formed to join and extend from the 3D printed sole material or there can be a gap between the sole material and the 3D printed fastening members. It is possible to produce the outer sole and fastening members on the same base material during the same 3D printing process.

Excess material can be removed after the additive process onto the base material. The removal can be provided by any appropriate tool, for example by laser or waterjet cutting, mechanical cutting and so forth.

The piece of material on which material can be added to can comprise e.g. a sheet of fabric, leather, synthetic leather, felt, plastic, rubber and/or foam material, or any combination of materials as appropriate

An example of the process of printing on a substrate provided by a component of the footwear is illustrated in FIGS. 21A, 21B and 21C. In FIG. 21A a 3D print head 154 has just started to lay down a first thin layer of material 155 on a substrate. The substrate can be provided e.g. by sheet material 150 as explained in above example where the sheet material provides also the sock of a shoe. The initial layers of the material fuse with the sheet material, thus providing a good bond between the sock and the sole in the finished product.

In FIG. 21B the thickness of the added material 155 has grown to a thickness where shaping of the remaining height of the sole component 151 is needed. FIG. 210 illustrates how the print head 154 adds material 155 only in areas of the sole component 151 that are thicker than the rest of the sole component.

FIGS. 22A and 22B illustrate schematically a sectioned view according to yet another example. A support tool 172 is provided such that the upper side thereof provides a shaped support for the sheet material 170 on which the 3D printing takes place. For example, the support block can provide the shape of the bottom of a last, or in other words the upper side of a sole such that sock material can be laid thereon before adding ‘printed’ material 175 on the material placed on the block by the print head 174. When the 3D printed material 171 has cooled, the shape of the block 172 is copied on the manufactured sole component, and thus a ready shaped complete sole component can be produced. In some applications it may possible to provide the support block by a bottom of a last.

Instead of sock material, the 3D printed material can be added on another component such as insole. FIG. 13 shows another example where a sole component 99 is 3D printed on a substrate formed by a part of the footwear, in this case upper material extending under or forming a foot bed.

The print head 154, 174 can be operated such that material 155, 175 is layered on to the substrate 150, 170 in appropriate angles. The print head can be arranged to operate in e.g. a 5-axis or 7-axis control system. The operation of the printing head can be controlled by an appropriate combination of control apparatus and software.

FIG. 23 illustrates examples of 3D printed lightweight components. For example honeycomb or other lattice, grid or net like structures providing a desired strength and/or flexibility, minimal weight and optimised use of material can be produced. 3D printing gives greater freedom to design internal parts of components to achieve optimal strength with minimal use of materials. Various other parts and components can also be produced by 3D printing. For example, eyelets and other cut-outs and openings, or strengthening of the edges thereof can be provided by 3D printing.

A sole component can also be arranged to have a moulded fastening member as described above. Such sole components may comprise at least one part of a sole and at least one moulded fastening member arranged for fastening at least one part of the sole to an upper and/or to a second part of the sole. For example, material can be moulded on a sock or foot bed material such that a fastening member is produced for locking into another component of the sole or to upper.

FIG. 24 is a flowchart according to a method for manufacturing a component for an article of footwear. Material is added by 3D printing at 200 on a first portion of the component to form a second portion of the component. The 3D printing comprises bonding the 3D printed material of the second portion with the material of the first portion. This may take place e.g. by fusing mechanically and/or chemically 3D printed material and the material of the first portion. The printing is further arranged such that the second portion is formed at 202 to provide a fastening member for fastening the component to another component of the article of footwear. Steps 200 and 202 can take place in parallel.

FIG. 25 is a flowchart according to another method for manufacturing a component for an article of footwear. In this method material is added at 300 on a first portion of the component at by moulding to form at 302 a second portion of the component such that the second moulded portion provides a fastening member for fastening the component to another component of the article of footwear. Moulding at 300 comprises bonding the moulded material of the second portion with the material of the first portion. Steps 300 and 302 can take place in parallel.

The additive forming may be for producing a structural element of the article of footwear. Material may be added on a substrate provided by a part of the article of footwear. The part may comprise sheet like material forming a part of a sole component or an upper component. A grid like structure of bars or slots may be printed.

A component may be fastened to another component by adding material on the surfaces of the components that have been positioned next to each other.

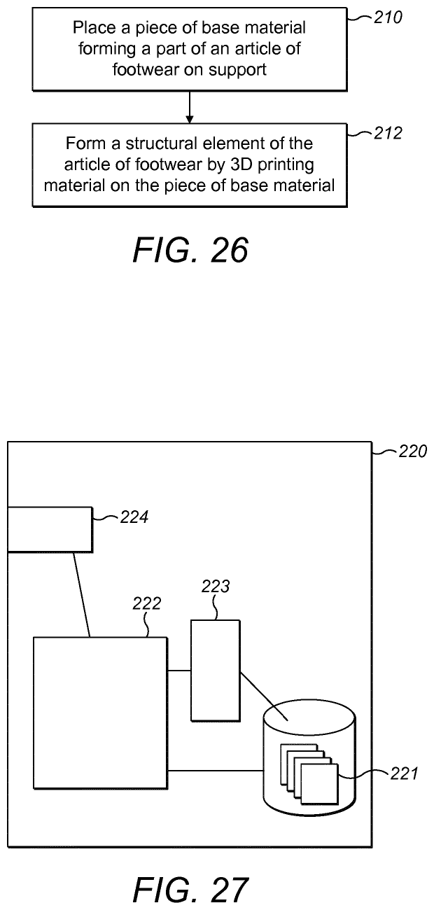

FIG. 26 shows yet another embodiment of manufacturing a component for an article of footwear. In the example the method comprises placing a piece of material forming a part of the article of footwear on a support at 210. The piece can comprise a sheet or layer of base material. A structural element of the article of footwear is then formed at 212 by moving a 3D print head relative to the piece of material to 3D print material on the piece of material on the support such that the printed material is bound with the piece of material. The structural element can comprise a sole or an upper. The layer of base material can comprise material e.g. for a sock, insole or an upper. The base material can be placed on a support having a 3 dimensional shape, e.g., the shape of a bottom of a last.

An article of footwear may be completely 3D printed. In other embodiments, depending on the requirements, the majority of an article of footwear is produced by 3D printing. An article of footwear can be produced in front of a customer by 3D printing based on measurements taken for the customer. Measurements may be taken e.g. based on digital imaging and/or use of touchscreen technologies and/or foot size and shape information database. The data can be automatically converted into control software code suitable for controlling the manufacturing process.

The material to be used for 3D printing or moulding can be selected to have such properties that no separate curing process after printing or moulding is necessary. That is, after e.g. 3D printing the printed portion can be left to cool and settle without the need to use any curing agent. This is possible because of the selected printing material. Additionally, in certain applications the portions produced by the printing or moulding process may be selected to be ones that do not require the shapes and forms to be produced as accurately as would be the case e.g. with logos and specific figurative patterns. Instead, herein described techniques may be used to produce structural features of components in flexible manner, which are less aesthetically important. The material can be in semi-liquid state at the time of printing, and adapted to bond mechanically and chemically with substrate material.

Ecological considerations of footwear manufacture and lifecycle are becoming increasingly important. For example, a desire is to use as little energy, materials and/or chemicals as possible. Further, easy recycling the footwear at the end of their useful life may be desired. This can be made easier to achieve by techniques as described above since the amount of materials used can be optimised. Fastening members of different components can be designed and produced such that disassembly of the footwear components made of different materials may not need special and/or expensive equipment. Also, local and/or customised and/or on-demand manufacturing may be facilitated in certain embodiments, and thus need for transportation and storage of footwear manufactured in faraway locations may be reduced.

The additive process, such as operation and movement of a 3D print head relative to the component to be manufactured, and/or movement of a support on which the printing takes place, can be controlled by one or more controller units. FIG. 27 shows an example of control apparatus. The control apparatus 220 can be for example integrated with, coupled to and/or otherwise controlling a moulding apparatus, a 3D printing apparatus, a robot or another actuator device. For this purpose the control apparatus comprises at least one memory 221, at least one data processing unit 222, 223, and an input/output interface 224. Via the interface the control apparatus can be coupled to the devices it is indented to control and/or a communication system for communication with other data processing apparatus, for example a manufacturing, measurement data and/or stock management control system. The control apparatus can be configured to execute an appropriate software code to provide control functions required by processes described herein.

While certain aspects of the invention may be illustrated and described as block diagrams, flow charts, or using some other schematic pictorial representation, it is well understood that these blocks, apparatus, systems, techniques and control methods described herein may be implemented in, as non-limiting examples, hardware, software, firmware, special purpose circuits or logic, general purpose hardware or controller or other computing devices, or some combination thereof.

The foregoing description provides by way of exemplary and non-limiting examples a full and informative description of exemplary embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the spirit and scope of this invention.

1.-37. (canceled)

38. A component for an article of footwear, the component comprising a first portion of base material and a second portion of added material, wherein the second portion is bonded to the base material of the first portion by a process of adding material on the base material and the added material forms at least one fastening member for assembly of the component to another component of the article of footwear.

39. The component for an article of footwear according to claim 38, wherein the at least one fastening member is configured to engage with a co-operating fastening member provided at the other component.

40. The component for an article of footwear according to claim 38, comprising at least a part of an upper, wherein the at least one fastening member is arranged for fastening the upper to a sole.

41. The component for an article of footwear according to claim 38, comprising a first part of an upper, wherein the at least one fastening member is arranged for fastening the first part of the upper to a second part of the upper.

42. The component for an article of footwear according to claim 38, comprising at least a part of a sole, wherein the at least one fastening member is arranged for fastening the at least one part of the sole to an upper and/or to a second part of the sole.

43. The component for an article of footwear according to claim 38, wherein the added material is applied on adjoining surfaces of the first portion and the other component so that a fixed joint is provided by the added material between the component and the other component.

44. The component for an article of footwear according to claim 38, wherein the at least one fastening member comprises at least one barbed element or clasp element for locking to the other component.

45. The component for an article of footwear according to claim 38, wherein the at least one fastening member comprises a grid structure or at least one aperture for locking to the other component.

46. The component for an article of footwear according to claim 38, wherein the at least one fastening member comprises at least one opening for receiving a holding member.

47. The component for an article of footwear according to claim 38, wherein the at least one fastening member comprises at least one tongue like element extending from the first portion for fastening to the other component.

48. The component for an article of footwear according to claim 38, wherein the at least one fastening member is 3D printed or moulded.

49. The component for an article of footwear according to claim 48, wherein the second portion is 3D printed or moulded on the first portion such that the 3D printed or moulded material forms a rim extending substantially around the entire outer edge of the first portion.

50. The component for an article of footwear according to claim 48, wherein the second portion is 3D printed or moulded on the first portion such that the 3D printed or moulded material covers only a part of the outer edge of the first portion.

51. The component for an article of footwear according to claim 38, wherein the added material of the second portion is adhered to the material of the first portion by mechanical and chemical bonding.

52. The component for an article of footwear according to claim 38, wherein the added material provides a structural element of the article of footwear.

53. The component for an article of footwear according to claim 38, wherein the added material comprises at least one of thermoplastic polyurethane, thermoplastic elastomer, thermosetting polymer and two-part thermosetting polymer and the first portion comprises at least one of leather, synthetic leather, fabric, felt, rubber, plastic, and foam material.

54. An article of footwear comprising a first component and a second component, wherein the first component comprises a first portion of base material and a second portion of added material, wherein the second portion is bonded to the base material of the first portion by a process of adding material on the base material and the added material forms at least one fastening member for assembly of the first component to the second component, and wherein the second component comprises co-operating at least one fastening member arranged for locking the components to each other.

55. The article of footwear according to claim 54, wherein the second component comprises a sole, the at least one fastening member comprises a grid structure for engaging with the sole, and the sole comprises grooves or recesses arranged for locking with the grid structure.

56. The article of footwear according to claim 54, wherein the second component comprises a sole, the at least one fastening member comprises at least one protruding element for engaging with the sole, and the sole comprises at least one receiving member arranged for locking with the protruding element.

57. The article of footwear according to claim 54, comprising one of a sandal, a shoe, and a boot.

58. A method of manufacturing a component for an article of footwear, the method comprising adding material on a first portion of the component to form a second portion of the component such that the second portion provides a fastening member for assembly of the component to another component of the article of footwear, the adding comprising bonding the added material of the second portion with the material of the first portion.

59. The method according to claim 58, where the adding of material comprises at least one of 3D printing material on the first portion, moulding material on the first portion, fusing the material of the second portion with the material of the first portion, producing a grid structure, adding material on a sheet like substrate provided by material forming a part of a sole component or an upper component, joining the components by applying material between the components, joining the components by 3D printing or moulding material on surfaces of the components, adding 3D printing material that settles without use of curing agent, controlling position of a 3D print head by a control system providing control on at least 5-axis of movement of the 3D print head, and forming a structural element of the article of footwear.

60. The method according to claim 58 wherein the component comprises an upper or a part of an upper, the adding comprising bonding material with upper material.

61. The method according to claim 58, comprising 3D printing material on the first portion by fused deposition modelling.

62. The method according to claim 58, wherein the first portion comprises sheet material for a sock or insole of a sole, the method comprising 3D printing at least a part of the sole and the at least one fastening member on the sheet material.
